(19) United States
(12) Patent Application Publication
(10) Pub. No.: US 2004/0186704 A1
(43) Pub. Date: Sep. 23, 2004

(54) Fuzzy based natural speech concept system

(76) Inventors: Jiping Sun, Waterloo (CA); Otman A. Basir, Waterloo (CA); Fakhreddine Karray, Waterloo (CA)

Correspondence Address: CARLSON, GASKEY & OLDS, P.C., 400 WEST MAPLE ROAD, SUITE 350, BIRMINGHAM, MI, 48009, US

(21) Appl. No.: 10/733,168

(22) Filed: Dec. 11, 2003

Related U.S. Application Data
(60) Provisional application No. 60/432,521, filed on Dec. 11, 2002.

(51) Int. Cl. G06F 17/28

(52) U.S. Cl. 704/4

(57) ABSTRACT

A fuzzy natural speech concept system includes: (i) a concept classification, (ii) a fuzzy conceptual grammar learning, and (iii) a natural language concept derivation system. In the system, errors due to user input complexity and recognizer problem are compensated for because the broad context is measured as a fuzzy set to which a correct concept belongs. If used in an automatic telephone conversation system, the fuzzy natural speech concept system will provide enough information about the intentions of the user as to take the most appropriate action to provide useful information and service to the user.

This application claims priority to U.S. Provisional Application Serial No. 60/432,521, filed Dec. 11, 2002.

### BACKGROUND OF THE INVENTION

The present invention is mainly directed to a fuzzy utterance concept detection and conceptual grammar learning system.

Automatic telephone conversation systems, which are activated in response to a user request through speaking into the telephone, are well known in the IT industry. A conversation system may contain automatic speech processing units such as a speech recognition engine (transferring speech to text), a TTS engine (transferring text to speech), a natural language understanding engine, a conversation flow management engine and a communication channel to business servers. The natural language understanding engine may further include a concept lexicon and a parser for grasping the intentions and indications contained in a user's utterance and for providing this information to the conversation system.

Several known automatic telephone conversation systems include a natural language understanding system for utterance meaning detection. The natural language understanding system could consist of semantic lexicons, keyword lists and a parser for detecting the meanings represented by the keywords and their combinations. A conversation manager or controller, which is connected to one or a combination of these parsers, controls the conversation flow and communication channels to business servers. In response to the detected meanings, one or more deployment aspects of the conversation system, such as the natural language generation and TTS engine, may be invoked. A telephone conversation system with natural speech understanding capabilities is commonly referred to as a “mixed initiative” conversational system. This type of systems is considered as having advantages to menu-driven systems. Specifically, if the user's intention and indication is broad and comes in free order, building a menu system would be impractical and it may be desirable to let the user speak freely than listening to a menu list.

Grammar acquisition and concept understanding are key components of mixed initiative conversation systems. There are several types of such systems but many of them suffer from serious shortcomings. A system that classifies concepts based on a keyword list (and their aliases) may be misled if the word is mis-recognized, for instance. A system that classifies the concepts based on pre-defined speech templates may not be reliable as people may speak under different situations, in different styles and specificities. A system that relies solely on a pre-defined grammar cannot account for false recognitions due to the non-robustness of rule-based grammar parsing. Different noises such as mis-recognized words, re-phrasing, hesitation, false start, filler words, for instance, could fail the parser. Also, a partial parse-based system relying on semantic rules for re-assembling the meaning of the complete sentence suffers from the lack of information for creating sufficient semantic rules.

### SUMMARY OF THE INVENTION

In a user speech meaning detection system according to the present invention, errors due to user input complexity and recognizer problem are compensated for because the broad context is measured as a fuzzy set to which a correct concept belongs. This invention provides a simple yet reliable method to compensate for the missing factors to accurately classify concepts and determine the user's intention and indication.

The present invention provides a novel fuzzy natural speech concept system that includes: (i) a concept classification and fuzzy conceptual grammar, (ii) a fuzzy concept grammar learning system, and (iii) a system for concept derivation from the speech of the user.

In accordance with the preferred embodiment of the present invention, the fuzzy speech concept system and fuzzy conceptual grammar comprise: (a) one or more semantic lexicons, and (b) one or more natural speech corpora.

As for the grammar learning and concept derivation modules, it comprises: (a) a concept classification unit, (b) a fuzzy concept grammar-learning unit, (c) a concept derivation unit, and (d) a testing and evaluation unit. These units work in certain order to form development cycles: First, with a given semantic lexicon and a natural speech corpus (transcripts of voice recordings), the concept classification unit generates a concept classification database specific to the corpus; Second, the grammar learning unit generates a fuzzy concept grammar; Third, the concept derivation unit applies the derived grammar to a set of test utterances; Fourth, the test and evaluation unit evaluates the performance of the system. Based on the evaluation, adjustments may be made to the concept classification and the system “re-learns” the grammar. Once the development cycle is over, the system can be used as the natural language understanding engine in a telephone conversation system.

The present invention has no restrictions on the type of semantic lexicon and natural speech corpora to be used. Any type of hierarchical semantic lexicon and raw text corpora can be used as long as they provide the system with the information of word classification and co-occurrence information.

### BRIEF DESCRIPTION OF THE DRAWINGS

Other advantages of the present invention can be understood by reference to the following detailed description when considered in connection with the accompanying drawings wherein:

FIG. 1 is a schematic block diagram of the fuzzy natural speech concept system (FNCS);

FIG. 2 is a flow chart of the concept classification algorithm;

FIG. 3 is a flow chart of the fuzzy concept grammar learning algorithm;

FIG. 4 is a flow chart of the concept derivation algorithm;

FIG. 5 is block diagram of the test evaluation algorithm.

FIG. 6 is a schematic of a computer on which the FNCS of FIG. 1 can be implemented.

### DETAILED DESCRIPTION OF THE PREFERRED EMBODIMENTS

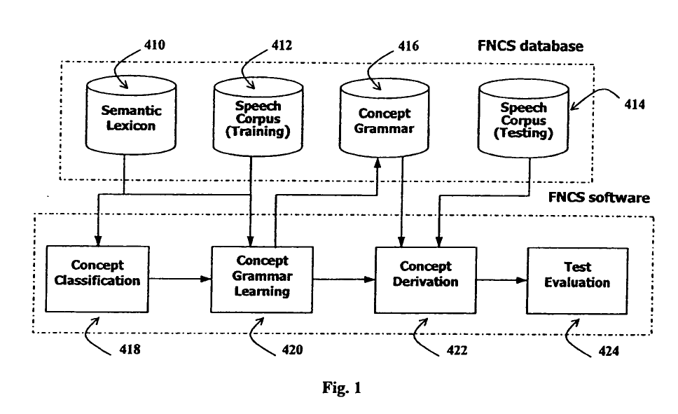

Referring to FIG. 1, a fuzzy natural language concept system (FNCS) includes one or more lexical databases 410, 412, 414, installed on a computing device, and they can be accessed in either reading or writing mode by any of the software modules. Any lexical database that meets certain specifications may be used. An example of such types of lexical database is the semantic lexicon WordNet, which provides a hierarchical classification of the English vocabulary. An example of a speech corpus is ATIS, which contains over twelve thousand of transcribed utterances in the air travel information domain. The fuzzy natural speech concept system (FNCS) also comprises a fuzzy concept grammar database 416 containing the results of the concept grammar-learning module 420. There are no restrictions on the type of database to be used as a grammar database. A possible candidate of such types of database is a Prolog database, for instance, containing clauses describing fuzzy sets in which a concept may belong.

Given the lexical semantic information provided by database 410, and statistical information provided by database 412, the concept classification module 418 classifies concepts in database 412 into domain specific categories and sends them to the concept grammar learning module 420. The concept classification system uses an algorithm to automatically detect the statistically significant concepts in the corpus and map words in the corpus to these concepts. The output of the module 420 is a fuzzy concept grammar 416. The fuzzy concept grammar 416 contains fuzzy inference rules, which assigns fuzzy membership to concepts using context vectors (left and right words of a concept in an utterance). The fuzzy concept grammar 416 is applied by the concept derivation module 422 to utterances in test corpus 414. Finally, a test and evaluation module 424 calculates the success rates of the concept derivation. Depending on the evaluation results, a further development cycle may be initiated, by modifying the classification, increasing the training data, adjusting the parameters of the respective modules. Otherwise, the concept derivation module, together with the fuzzy concept grammar is delivered as the natural language understanding component of the automatic telephone conversation system.

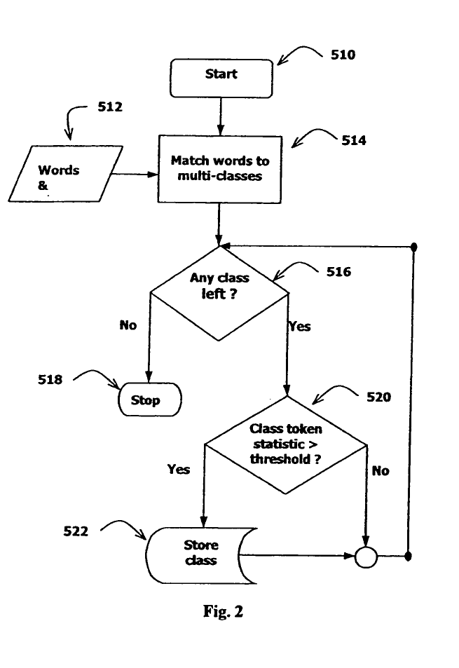

FIG. 2 provides a flow chart showing the algorithmic steps in the concept classification system, which is to decide whether a concept is significant to the domain in which the corpus is embedded. This is done through the statistical procedures 514 and 520. In case a significant concept is detected, the system stores it in storage 522. This whole process is repeated for all the words in the training corpus, which are assigned multiple concepts by use of the semantic lexical database (ref. 410 of FIG. 1), taken from input 512.

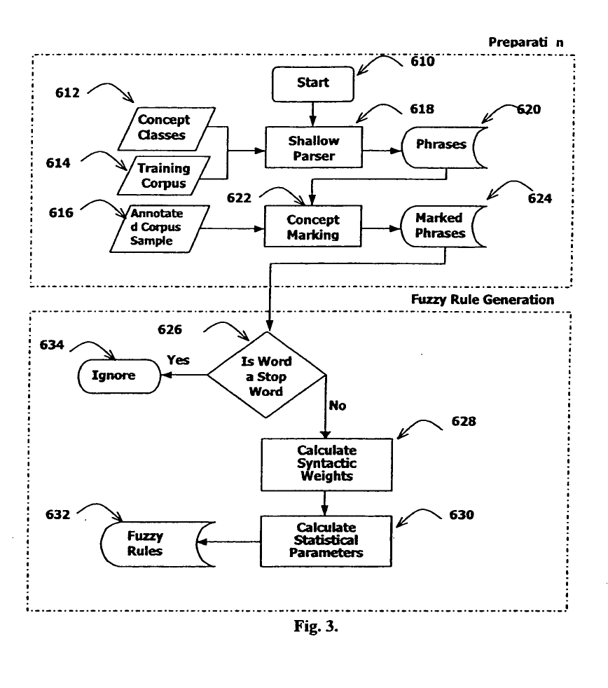

FIG. 3 is the flow chart depicting the system of concept grammar learning. The process starts from a preparation stage. Concept classes 612 derived from the concept classification module and train texts 614 are processed by a shallow parser 618. The results are semantic phrases, which are stored in 620. The concept marking module 622 then marks the words of 620 with concepts from an annotated corpus sample 616 and stores the results in storage 624. In the fuzzy grammar rules generation stage, the marked phrases are processed word by word. Test point 625 checks if a context word is a stop word and ignores it when it is the case. Otherwise, this context word is used to calculate (1) syntactic weights and (2) statistical parameters for a fuzzy concept rule, in relation to an annotated concept by modules 628 and 630. The derived fuzzy concept rules are stored in 632.

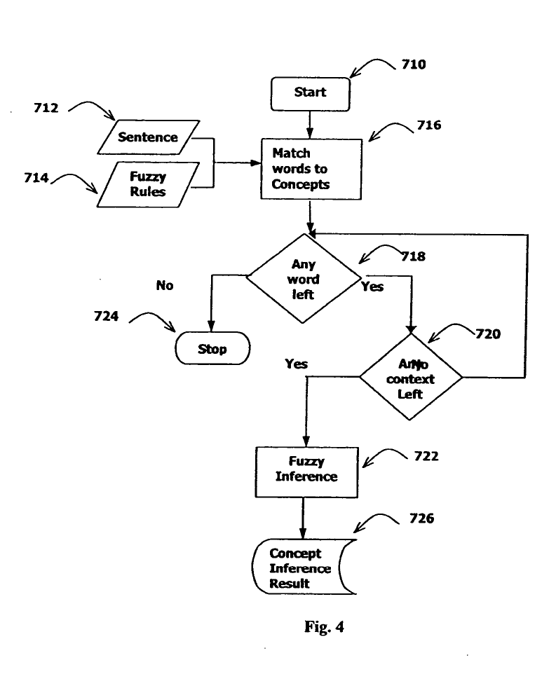

FIG. 4 depicts the top-level flow-chart of the concept derivation module, which accepts a sequence of words and derives the concepts intended by the speaker, by use of the fuzzy concept rules. At start sentence 712 and fuzzy rules 714 are input to module 716 in which the words are given possible concepts. At test point 720 words surrounding the concept are examined one by one. When a context word is found, it is sent to fuzzy inference module 722 to assist the inference of a correct concept. The whole process checks all the words in the input sentence by the loop implemented with the test point 718 and the and stop point 724. The results of applying and inference with the fuzzy rules are stored in the storage 726, in the form of assigned concepts to words in the input sentence. It should be clarified at this point as to the difference between the matching results of module 716 and the inference results of the module 722: in the former, a word is matched to a number of “possible” concepts according to the previous learning; and in the later, one of the possible concepts is selected and assigned to the word by applying the inference rules to the context words surrounding the word in the sentence.

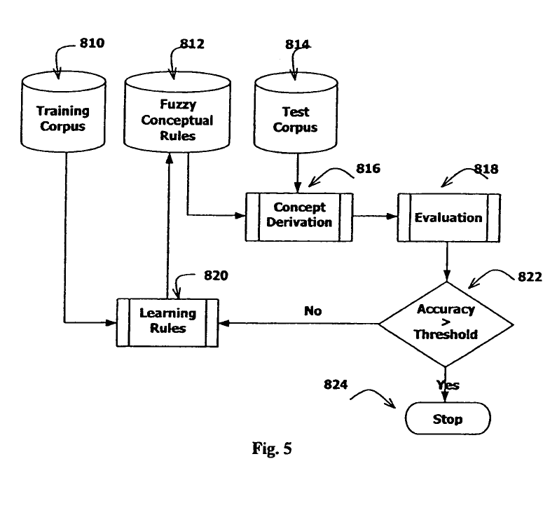

FIG. 5 is a block diagram depicting the process of a fuzzy concept system development cycle. The fuzzy concept (grammar) rule is learned by module 820. The results of learning are tested with an independent test corpus 814 and the concept derivation module 816. The performance of the test is analyzed by evaluation module 818. The test point 822 examines whether the performance has passed a threshold of accuracy. When the test has passed the accuracy requirement, the derived fuzzy rules can be delivered to the telephone conversation system as the NLP module. Otherwise, more training is done by goes through the training cycle again to improve the system accuracy.

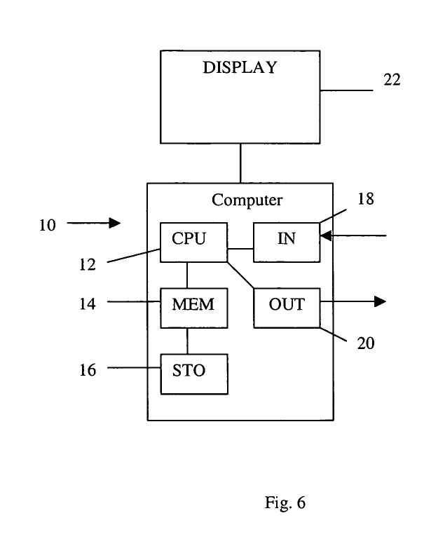

FIG. 6 is a schematic for a computer 10 on which the fuzzy natural language concept system described above can be implemented. The computer 10 includes a CPU 12, memory 14, such as RAM, and storage 16, such as a hard drive, RAM, ROM or any other optical, magnetic or electronic storage. The computer 10 further includes an input 18 for receiving the speech input, such as over a telephone line, and an output 20 for producing the responsive speech output, such as over the telephone line. The computer 10 may also include a display 22. The algorithms, software and databases described above with respect to FIGS. 1-5 are implemented on the computer 10 and are stored in the memory 14 and/or storage 16. The computer 10 is suitably programmed to perform the steps and algorithms described herein.

From the above description of a preferred embodiment of the invention, those skilled in the art will perceive improvements, changes and modifications. Such improvements, changes and modifications within the skill of the art are intended to be covered by the following claims.

What is claimed is:

1. A concept classification system that classifies concepts for a domain according to the statistical significance of these concepts in the domain comprising:
at least one general semantic lexicon, implemented as a computational database and accessible by the software modules of the classification system;
at least one text corpus, containing texts specific for a domain for an application of a telephone conversation system, implemented as a computational database; and
a statistical inference algorithm, which makes use of distributional patterns of words in the corpus, together with their conceptual categories in the general semantic lexicon, to derive significant concepts of a particular domain.

2. A fuzzy grammar rule derivation system to learn fuzzy grammar from corpora comprising:
a shallow parsing algorithm, which assigns syntactic categories to words and segments a sentence into syntactic phrases;
a syntactic weight assignment algorithm, which assigns syntactic weight to context vectors according to their relative importance to a concept; and
a statistical parameter calculation algorithm, which assigns frequency and differentiation parameters to context vectors of concepts.

3. A concept derivation system, which applies fuzzy grammar rules to a sentence to derive the intended meanings of the speaker comprising:
a matching algorithm to match words to possible multiple concepts, as described in the fuzzy grammar;
a fuzzy inference algorithm which applies fuzzy grammar rules to the context vector of a possible concept and assigns a membership degree to the concept;
an evaluation algorithm, which examines the test results of the fuzzy grammar rule engine and the inference engine to decide if further training of the system is needed or the system has passed the requirement for delivery as the natural language understanding component of a telephone conversation system.
